(19) United States
(12) Patent Application Publication
(10) Pub. No.: US 2008/0224595 A1
(43) Pub. Date: Sep. 18, 2008

(54) Organic EL device

(75) Inventors: Yuko Nakamata, Matsumoto City (JP); Yukinori Kawamura, Matsumoto City (JP); Toshio Hama, Matsumoto City (JP); Koji Kawaguchi, Matsumoto City (JP); Yutaka Terao, Matsumoto City (JP)

Correspondence Address: RABIN & Berdo, PC, 1101 14TH STREET, NW, SUITE 500, WASHINGTON, DC, 20005, US

(73) Assignee: FUJI ELECTRIC HOLDINGS CO., LTD., Kawasaki (JP)

(21) Appl. No.: 12/076,003

(22) Filed: Mar. 12, 2008

(30) Foreign Application Priority Data
Mar. 14, 2007 (JP) 2007-065276

(51) Int. Cl. H01J 1/62

(52) U.S. Cl. 313/500

(57) ABSTRACT

The present invention provides a high-efficiency organic EL device that can be fabricated by a simple process and that can prevent color shift arising from variations in film thickness. The organic EL light-emitting device includes a plurality of independent light-emitting elements that constitute first, second, and third emission color subpixels. The light-emitting elements constituting the first emission color subpixels and the second emission color subpixels have a semitransparent reflective layer between a transparent substrate and a transparent electrode, and this semitransparent reflective layer is configured so as to function with the reflective electrode as a resonator for the light of the emission colors. The light-emitting elements constituting the third emission color subpixels additionally have a color conversion layer between the transparent substrate and the transparent electrode.

### CROSS-REFERENCE TO RELATED APPLICATION

This application claims the benefit of priority of Japanese application number 2007-065276, filed on Mar. 14, 2007, the disclosure of which is incorporated herein by reference.

### BACKGROUND OF THE INVENTION

1. Field of the Invention

The present invention relates to the structure of an organic electroluminescent (abbreviated below as organic EL) device used for an organic EL display that is capable of displaying multiple colors and that exhibits high precision and excellent visibility, for the backlight of color liquid crystal displays, and for other lighting devices.

2. Description of the Related Art

Organic EL devices having a structure in which organic compounds are layered in thin films are known as one example of the light-emitting devices that are used in display devices. Organic EL devices are autogenous thin-film light-emitting devices, and various investigations have been carried out in pursuit of their practical realization due to their excellent characteristics, such as low driving voltage, high resolution, and large viewing angle.

To date, much research focusing on raising the emission efficiency has been done in the field of EL devices. It is well known that one factor that reduces the emission efficiency of EL devices is that at least half of the light generated by the light-emitting layer ends up being trapped within the device or within the transparent substrate (Advanced Materials, Volume 6, p. 491, 1994).

The use of a microresonator structure is widely known as one method for raising the emission efficiency by enabling the emission of light trapped within the transparent substrate to the outside (Applied Physics Letters, Volume 64, p. 2486, 1994). Moreover, organic EL devices that employ this principle have been introduced (for example, Japanese Patent Application Laid-open No. H6-283271 and Japanese Patent 2,830,474).

When a microresonator structure is used, the photons emitted by the light-emitting layer are then output directionally, which enables a reduction in the proportion of light trapped within the transparent substrate. In addition, the use of a microresonator structure produces a sharper photon energy distribution (i.e., the emission spectrum) and has the effect of increasing the peak intensity by several times to several tens of times; this in turn provides a strengthening of the emission intensity produced by the light-emitting layer as well as a monochromatizing effect.

### SUMMARY OF THE INVENTION

However, when such a microresonator EL device is to be applied to a color display, the optical gap between the pair of mirrors constituting the resonator must be tuned for each subpixel population corresponding to the individual colors of red (R), blue (B), and green (G), which causes the fabrication process to be complex.

In addition, a large cavity length (overall film thickness of the layer between the semitransparent reflective layer and the reflective electrode) is required in order to simultaneously amplify the 3 colors (RGB) through the introduction of microresonator structures for all three colors, and such a film thickness is not practical. As the overall film thickness grows in this case, the problem of color shift being readily produced by minor variations in film thickness also arises.

The organic EL device of the present invention is an organic EL device comprising a plurality of independent light-emitting elements that contain a transparent electrode, an organic EL layer having at least a light-emitting layer, and a reflective electrode layered in sequence on a transparent substrate and that constitute first, second, and third emission color subpixels, wherein the light-emitting elements constituting the first emission color subpixels and the second emission color subpixels additionally have a semitransparent reflective layer between the transparent substrate and the transparent electrode and this semitransparent reflective layer is configured so as to function with the reflective electrode as a resonator for the light of the emission colors, and wherein the light-emitting elements constituting the third emission color subpixels additionally have a color conversion layer between the transparent substrate and the transparent electrode. The first emission color here may be blue; the second emission color may be red; and the third emission color may be green. Or, the first emission color may be blue; the second emission color may be green; and the third emission color may be red.

The luminance of each emission color can be increased and high-efficiency emission can be obtained by means of the structure described above, that is, by using a resonator structure for only the first emission color and the second emission color among the three emission colors and by using a color conversion layer for the remaining third emission color. The structure of the present invention, because it eliminates the requirement that the cavity length of the resonator structure be tuned for each and every emission color subpixel population and because it also eliminates the requirement for an impractically large cavity length, can be fabricated by a simplified process and can also prevent the color shift caused by variations in film thickness. The structure of the present invention is effective for the fabrication of organic EL devices for displays where high efficiency is critical.

### BRIEF DESCRIPTION OF THE DRAWINGS

FIG. 1 shows an example of the organic EL light-emitting device of the present invention;

FIG. 2 shows another example of the organic EL light-emitting device of the present invention; and

FIG. 3 is a graph that shows the emission spectra of the organic EL light-emitting elements of Example 1 and Comparative Example 1.

### DESCRIPTION OF THE PREFERRED EMBODIMENTS

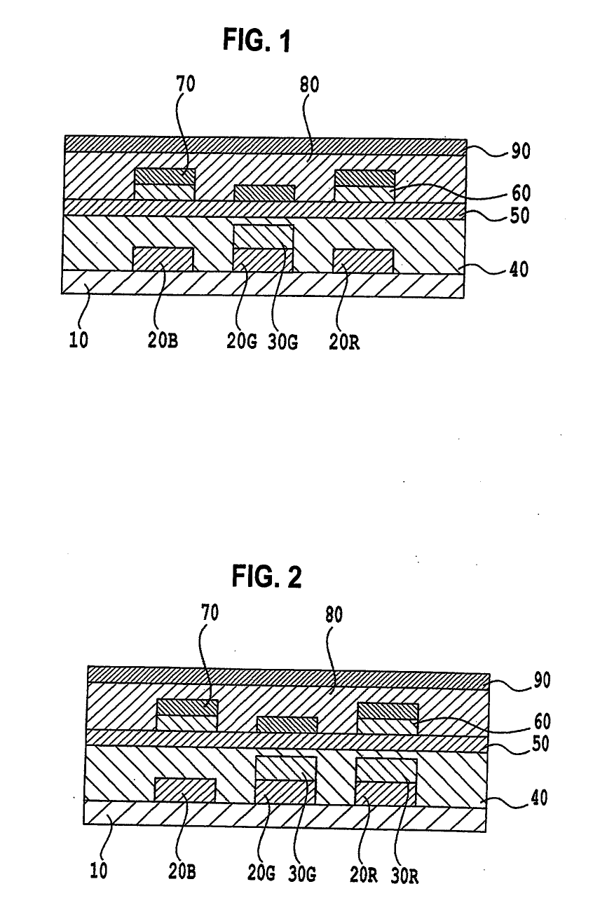

The organic EL device of the present invention will be described with reference to FIG. 1. The organic EL device in FIG. 1 comprises a plurality of independent light-emitting elements on a transparent substrate 10, wherein these light-emitting elements are constituted of three transparent electrodes 70, an organic EL layer 80, and a reflective electrode 90 and this plurality of independent light-emitting elements constitutes a first emission color subpixel, a second emission color subpixel, and a third emission color subpixel. FIG. 1 shows the case in which the first emission color is blue, the second emission color is red, and the third emission color is green. Two semitransparent reflective elements or layers 60 are disposed between the transparent substrate 10 and two of the transparent electrodes 70, in the light-emitting element constituting the first emission color (B) subpixel and the second emission color (R) subpixel. The semitransparent reflective layers 60 are constructed so as to function as optical resonators with the reflective electrode 90 for the pertinent emission colors (the first emission color and the second emission color). A color conversion element or layer 30 (G) is disposed, on the other hand, between the transparent substrate 10 and the transparent electrode 70 in the light-emitting element constituting the third emission color (G) subpixel. The color conversion layer 30 is a layer that absorbs a portion of the light produced by the organic EL layer 80 and emits light of the pertinent emission color (third emission color). The other layers shown in FIG. 1 (color filter elements or layers 20, planarizing layer 40, and passivation layer 50) are layers adopted on an optional basis, but whose disposition is desirable.

The transparent substrate 10 in the present invention can be formed from an inorganic material such as glass or can be formed of a polymer material such as a cellulose ester, polyamide, polycarbonate, polyester, polystyrene, polyolefin, polysulfone, polyether sulfone, polyetherketone, polyetherimide, polyoxyethylene, norbornene resin, and so forth. When a polymer material is used, the transparent substrate 10 may be rigid or flexible. The designation as optically transparent means that the transmittance for visible light is at least 80% and preferably is at least 86%.

The transparent electrodes 70 can be formed using ITO, bismuth oxide, indium oxide, IZO, zinc oxide, zinc-aluminum oxide, zinc-gallium oxide, or a transparent electroconductive metal oxide as afforded by adding a dopant, such as F or Sb, to the preceding oxides. The transparent electrodes 70 can be formed by vapor deposition, sputtering, or chemical vapor deposition (CVD), with formation by sputtering being preferred.

The reflective electrode 90 can be formed by a dry process, such as vapor deposition or sputtering, using a high reflectance metal (e.g., Al, Ag, Mo, W, Ni, Cr), amorphous alloy (e.g., NiP, NiB, CrP, CrB), or microcrystalline alloy (e.g., NiAl). The reflective electrode 90 has a reflectance preferably of at least 50% and more preferably of at least 80%.

The organic EL layer 80 has a structure that contains at least a light-emitting layer and in which a hole injection layer, hole transport layer, electron transport layer, and/or electron injection layer is (are) interposed on an optional basis. In specific terms, the organic EL device comprises a layer structure such as described in Table 1 below (the anode and cathode may be either the reflective electrode or the transparent electrode):

TABLE 1

| | |
|---|---|
| (1) | anode/organic light-emitting layer/cathode |
| (2) | anode/positive hole injection layer/organic |
| | light-emitting layer/cathode |
| (3) | anode/organic light-emitting layer/electron |
| | injection layer/cathode |
| (4) | anode/positive hole injection layer/organic |
| | light-emitting layer/electron injection |
| | layer/cathode |
| (5) | anode/positive hole transport layer/organic |
| | light-emitting layer/electron injection |
| | layer/cathode |
| (6) | anode/positive hole injection layer/positive |
| | hole transport layer/organic light-emitting |
| | layer/electron injection layer/cathode |
| (7) | anode/positive hole injection layer/positive |
| | hole transport layer/organic light-emitting |
| | layer/electron transport layer/electron |
| | injection layer/cathode. |

Known materials are used for the material of each layer constituting the organic EL layer. In addition, each layer constituting the organic EL layer can be formed using any method known in the concerned art, for example, vapor deposition.

The width of the light emission spectrum is preferably expanded in the present invention by the introduction of at least two dopants into the light-emitting layer. The introduction into the light-emitting layer of a dopant that emits in the region of the first emission color and a dopant that emits in the region of the second emission color is preferred. For example, with regard to the structure in FIG. 1, the introduction of a dopant that emits in the blue region and a dopant that emits in the red region is preferred.

The organic EL device of the present invention has a plurality of independently controlled light-emitting elements. For example, in order to form an organic EL device that has a plurality of passive matrix-driven light-emitting elements, both the transparent electrodes 70 and the reflective electrode 90 are formed from a plurality of stripe-shaped subelectrodes, and the direction of extension of the stripe-shaped subelectrodes constituting the transparent electrodes 70 is disposed in a direction that intersects (preferably orthogonally) the direction of extension of the stripe-shaped subelectrodes constituting the reflective electrode 90. With regard to the formation of the transparent electrodes 70, an insulating film may be formed, using an insulating metal oxide (e.g., TiO₂, ZrO₂, AlOₓ) or an insulating metal nitride (e.g., AlN, SiN), in the spaces between the electrodes.

The semitransparent reflective layers 60 are disposed in the light-emitting element comprising the first emission color subpixel and in the light-emitting element comprising the second emission color subpixel. The semitransparent reflective layers 60 are disposed between the transparent substrate 10 and the transparent electrodes 70, and preferably in contact with the side of the transparent electrodes 70 that is opposite from the organic EL layer 80. The semitransparent reflective layers 60 are layers whose purpose is to form an optical resonator structure by reflecting a portion of the light produced by the organic EL layer 80 toward the reflective electrode 90. The structure in FIG. 1 shows an example in which semitransparent reflective layers 60 are provided for the light-emitting element forming the blue (first emission color) subpixel and the light-emitting element forming the red (second emission color) subpixel. The semitransparent reflective layers 60 preferably have a reflectance of 10 to 50% and more preferably of 20 to 30%. The semitransparent reflective layers 60 can be formed using a material such as Ag or Al. In order to realize the aforementioned reflectance using these materials, the semitransparent reflective layers 60 preferably have a film thickness of 5 to 20 nm and more preferably have a film thickness of 10 to 15 nm.

The resonance of light in the two wavelength regions corresponding to the first emission color and the second emission color is obtained by establishing, as discussed in the following, an optical gap between a pair of mirrors (that is, the semitransparent reflective layers 60 and the reflective electrode 90) that form an optical resonator structure. Thus, letting the peak wavelength in the spectrum of the light of the first emission color and the second emission color be λ₁ (nm) and λ₂ (nm), respectively, and letting Φ (radian) be the phase shift in the reflected light produced upon reflection at both the semitransparent reflective layers 60 and the reflective electrode 90 surfaces, an optical gap L (nm) between the reflective electrode 90 and the semitransparent reflective layers 60 is established that satisfies both of the following equations (I) and (II).

2L/λ₁+Φ/2π=m₁(m₁=integer) (I)

2L/λ₂+Φ/2π=m₂(m₂=integer) (II)

This optical gap L is the sum of the products of the actual film thickness (nm) and the refractive index for the layers present between the reflective electrode 90 and the semitransparent reflective layers 60 (that is, the transparent electrodes 70 and the organic EL layer 80).

When the first emission color is blue and the second emission color is red, λ₁ is set in the range from 440 to 490 nm and λ₂ is set in the range from 600 to 650 nm and the optical gap L is tuned so as to satisfy equations (I) and (II), supra. λ₁ is preferably set at the peak emission wavelength of the blue dopant introduced into the light-emitting layer, and λ₂ is preferably set at the peak emission wavelength of the red dopant introduced into the light-emitting layer. While a dependence on the materials used also operates, in the present case, for example, an optical gap L that satisfies equations (I) and (II) can be obtained by making the actual film thickness of the organic EL layer 80 about 200 nm and making the actual film thickness of the transparent electrode 70, formed in this case from IZO, about 200 nm.

When, on the other hand, the first emission color is blue and the second emission color is green, λ₁ is set in the range from 440 to 490 nm and λ₂ is set in the range from 500 to 590 nm and the optical gap L is tuned so as to satisfy equations (I) and (II), supra. λ₁ is preferably set at the peak emission wavelength of the blue dopant introduced into the light-emitting layer, and λ₂ is preferably set at the peak emission wavelength of the green dopant introduced into the light-emitting layer. While a dependence on the materials used also operates, in the present case, for example, an optical gap L that satisfies equations (I) and (II) can be obtained by making the actual film thickness of the organic EL layer 80 about 265 nm and making the actual film thickness of the transparent electrode 70, formed in this case from IZO, about 400 nm.

Tuning the optical gap L as described above accrues the effect of improving the output efficiency of the organic EL light-emitting device of the present invention by narrowing the bandwidth of the emission spectra of the first and second emission colors and improving the directionality.

In addition, the emission efficiency of the organic EL light-emitting device of the present invention is improved by the disposition, without using a resonator structure, of a color conversion layer 30 in the light-emitting element that forms the third emission color subpixel. The structure in FIG. 1 shows an example in which a green color conversion layer 30G has been disposed at the location of the green (the third emission color) subpixel. The color conversion layer 30 is a layer comprising a matrix resin and a single color conversion dye or a plurality of color conversion dyes.

When the third emission color is green, the color conversion dye is a dye that absorbs the blue-region light produced by the light-emitting layer and emits light in the green region. The color conversion dyes that can be used in this instance encompass, for example, coumarin dyes such as 3-(2′-benzothiazolyl)-7-diethylaminocoumarin (coumarin 6), 3-(2′-benzoimidazolyl)-7-diethylaminocoumarin (coumarin 7), 3-(2′-N-methylbenzoimidazolyl)-7-diethylaminocoumarin (coumarin 30), and 2,3,5,6-1H,4H-tetrahydro-8-trifluoromethylquinolidine(9,9a,1-gh)coumarin (coumarin 153); basic yellow 51, which is a dye in the coumarin dye class; and also naphthalimide dyes such as solvent yellow 11 and solvent yellow 116.

When the third emission color is red, the color conversion dye is a dye that absorbs blue-to-green region light produced by the light-emitting layer and emits light in the red region, and preferably is a dye that absorbs blue-region light produced by the light-emitting layer and emits light in the red region. Color conversion dyes that can be used in this instance encompass, for example, rhodamine dyes such as rhodamine B, rhodamine 6G, rhodamine 3B, rhodamine 101, rhodamine 110, sulforhodamine, basic violet 11, and basic red 2; cyanine dyes; pyridine dyes such as 1-ethyl-2-[4-(p-dimethylaminophenyl)-1,3-butadienyl]pyridinium perchlorate (pyridine 1); and oxazine dyes. In addition, the color conversion efficiency may be improved through co-use with a dye that absorbs the aforementioned blue-region light and emits light in the green region.

The matrix resin used in the color conversion layer 30 encompasses thermoplastic resins as well as the cured product from photocuring and photothermal dual-curing resins (resist).

As shown in FIG. 2, a second color conversion layer 30 that emits the second emission color may, as an optional selection, also be disposed in the light-emitting element that forms the second emission color subpixel. The structure in FIG. 2 shows an example in which a red color conversion layer 30R has been disposed in the location of the second emission color (red) subpixel.

Color filter layers 20, each corresponding to a particular emission color, may be disposed, as an optional selection, in the organic EL light-emitting device of the present invention at locations conforming to the particular emission color subpixels and in contact with the transparent substrate 10. The structure in FIG. 1 shows an example in which color filter layers 20 (B, R, G) corresponding to the emission colors (blue, red, and green) have been disposed at the corresponding locations of the first to third emission color (blue, red, and green) subpixels. The color filter layers 20 improve the color purity of the transmitted light by passing only light in a prescribed wavelength region and stopping light in any other wavelength region. The color filter layers 20 can be formed using methods already known for use with flat panel displays and using commercially available materials for use in flat panel displays.

A planarizing layer 40 may also be disposed, as an optional selection, in the organic EL light-emitting device of the present invention; this planarizing layer 40 covers the color filter layers 20 (when such layers are present) and the color conversion layer(s) 30 on the transparent substrate 10. The planarizing layer 40 is a layer that planarizes the surface in order to eliminate the irregularities that can cause a short circuit between the transparent electrodes 70 and the reflective electrode 90. The planarization layer 40 may be composed of a single layer or may be composed of a plurality of materials in a layered structure. The materials that can be used to form the planarization layer 40 include imide-modified silicone resins; materials comprising a dispersion of an inorganic metal compound (e.g., TiO, Al₂O₃, SiO₂) in, for example, an acrylic resin, polyimide resin, silicone resin, and so forth; acrylate monomer/oligomer/polymer resin that contains reactive vinyl; resist resins; fluororesins; and photocurable resins and/or thermosetting resins such as epoxy resins, epoxy-modified acrylate resins, and so forth. The method of forming the planarization layer 40 using these materials is not particularly limited. For example, formation can be carried out by conventional procedures, such as dry methods (e.g., sputtering, vapor deposition, CVD, and so forth) and wet methods (spin coating, roll coating, casting, and so forth).

When a planarization layer 40 is present between the color conversion layer(s) 30 and the transparent electrode 70, a passivation layer 50 may be disposed, as an optional selection, on the planarization layer 40 in the organic EL light-emitting device of the present invention. This passivation layer 50 is effective for preventing the permeation of oxygen, low molecular weight components, and moisture from the underlying color conversion layer(s) 30, the underlying color filter layer 20 when such is present, and the underlying passivation layer 40, and thus is effective for preventing the reduction in the functionality of the organic EL layer 80 that can be caused by these species. The passivation layer 50 can be formed using, for example, materials such as a metal oxide such as SiOₓ, AlOₓ, TiOₓ, TaO, ZnOₓ, and so forth; a metal nitride such as SiNₓ and so forth; or a metal oxynitride such as SiNₓO_{y} and so forth.

### EXAMPLES

### Example 1

An organic EL device with the structure shown in FIG. 2 was fabricated. A transparent substrate 10 of 0.7 mm-thick glass was first ultrasonically cleaned in pure water and then dried and thereafter additionally cleaned with UV/ozone. Color Mosaic CK-7800 (Fujifilm Electronics Materials Co., Ltd.) was coated by spin coating on the cleaned glass substrate and, using photolithographic patterning, a black matrix (not shown) was formed comprising a plurality of stripe-shaped regions (width=0.03 mm, film thickness=1 μm) arrayed at a pitch of 0.11 mm.

Color Mosaic CB-7001 (Fujifilm Electronics Materials Co., Ltd.) was coated on the black matrix-bearing transparent substrate 10 and, using photolithographic patterning, a blue color filter layer 20B was formed comprising a plurality of striped-shaped regions (width=0.1 mm, film thickness=1 μm) extending in a first direction and arrayed at a pitch of 0.33 mm.

Color Mosaic CG-7001 (Fujifilm Electronics Materials Co., Ltd.) was then applied and, using photolithographic patterning, a green color filter layer 20G was formed comprising a plurality of striped-shaped regions (width=0.1 mm, film thickness=1 μm) extending in the first direction and arrayed at a pitch of 0.33 mm.

Color Mosaic CR-7001 (Fujifilm Electronics Materials Co., Ltd.) was then applied and, using photolithographic patterning, a red color filter layer 20R was formed comprising a plurality of striped-shaped regions (width=0.1 mm, film thickness=1 μm) extending in the first direction and arrayed at a pitch of 0.33 mm.

Coumarin 6 (0.9 weight part) was then dissolved in 120 weight parts propylene glycol monoethyl acetate (PGMEA) as solvent. A coating solution was obtained by the addition of 100 weight parts V259PA/P5 photopolymerizable resin composition (Nippon Steel Chemical Co., Ltd.) with dissolution. This coating solution was coated on the substrate by spin coating and a green conversion layer 30G was obtained on the green color filter layer 20G by photolithographic patterning. This green conversion layer 30G comprised a plurality of stripe-shaped regions (width=0.1 mm, film thickness=5 μm) extending in the first direction; this plurality of stripe-shaped regions was arrayed at a pitch of 0.33 mm.

A coating solution was then obtained by dissolving coumarin 6 (0.5 weight part), rhodamine 6G (0.3 mass part), and basic violet 11 (0.3 mass part) and adding 100 weight parts V259PA/P5 with dissolution. This coating solution was coated on the transparent substrate by spin coating and a red conversion layer 30R was obtained on the red color filter layer 20R by photolithographic patterning. This red conversion layer 30R comprised a plurality of stripe-shaped regions (width=0.1 mm, film thickness=5 μm) extending in the first direction; this plurality of stripe-shaped regions was arrayed at a pitch of 0.33 mm.

V259PA/P5 was coated on the transparent substrate 10 on which the color filter layers 20 and color conversion layers 30 had been formed; this was followed by exposure to light from a high-pressure mercury lamp to form a planarization layer 40 having a film thickness of 8 μm. No deformation was produced at this time in the stripe shape of the color filter layers 20 and the color conversion layers 30, and the upper surface of the planarization layer 40 was flat.

A passivation layer 50 comprising SiN film with a film thickness of 300 nm was formed on the planarization layer 40 using a parallel flat plate plasma CVD tool. The atmosphere was 50 sccm SiH₄ gas and 200 sccm N₂ gas. 150 W was used for the applied RF power and 60° C. was used for the substrate stage temperature.

A silver alloy film (APC-TR from Furuya Metal) with a film thickness of 12 nm was formed on the top side of the passivation layer 50 by sputtering (DC magnetron). A photoresist (TFR-1250 from Tokyo Ohka Kogyo Co., Ltd.) with a film thickness of 1.3 μm was formed by spin coating over the silver alloy film and was dried over 15 minutes at 80° C. in a clean oven. The photoresist was then exposed through a photomask to ultraviolet light from a high-pressure mercury lamp and was developed with a developing solution (NMD-3 from Tokyo Ohka Kogyo Co., Ltd.), thereby producing a photoresist pattern on the silver alloy film. The photomask used had stripe-shaped light-opaque regions (width=0.094 mm) in positions corresponding to the blue color filter layer 20B and the red color filter layer 20R.

The silver alloy film was then etched using an etching solution for silver. (SEA2 from Kanto Chemical Co., Inc.) and the photoresist pattern was thereafter stripped off using a resist stripping solution (Stripper 106 from Tokyo Ohka Kogyo Co., Ltd.) to yield a semitransparent reflective layers 60, comprising the patterned silver alloy, in the positions corresponding to the blue color filter layer 20B and the red color filter layer 20R.

An IZO film having a film thickness of 220 nm was then formed by DC sputtering. The formation of this IZO film was carried out under the following conditions: sputtering gas=Ar at a pressure of 0.3 Pa; target=In₂O₃-10% ZnO; applied power=100 W. The film formation rate during this process was 0.33 nm/s. The execution of photolithographic patterning, drying (150° C.), and UV treatment (mercury lamp, room temperature and 150° C.) then yielded, in the positions corresponding to the color filter layers 20 of each color, transparent electrodes 70 (anode) comprising a plurality of stripe-shaped subelectrodes (width=0.094 mm, pitch=0.11 mm, film thickness=100 nm) extending in the first direction.

The transparent electrode 70-equipped laminate was then installed in a resistance-heated vapor deposition apparatus and an organic EL layer 80 having an overall film thickness of 226.8 nm and comprising a hole injection layer, a hole transport layer, a light-emitting layer, and an electron transport layer was formed by sequential film formation without breaking the vacuum. The pressure in the vacuum chamber during film formation was dropped to 1×10⁻⁵ Pa. The hole injection layer was formed as a co-vapor-deposited film (film thickness=177 nm) of 4,4′,4″-tris[(3-methylphenyl)phenylamino]triphenylamine (m-MTDATA) and 2,3,5,6-tetrafluoro-7,7,8,8-tetracyanoquinodimethane (F4-TCNQ) in which m-MTDATA:F4-TCNQ=100:2 as the component ratio based on film thickness. N,N′-bis(1-naphthyl)-N,N′-diphenylbiphenyl-4,4′-diamine (α-NPD) was stacked in a film thickness of 10.7 nm as the hole transport layer. The light-emitting layer was formed by layering a co-vapor-deposited film (film thickness=16.7 nm) of 4,4′-bis(2,2-diphenylvinyl)biphenyl (DPVBi), the blue dopant BD-102 (from Idemitsu), and the red dopant RD-001 (from Idemitsu) in which DPVBi:BD-102:RD-001=100:3:0.15 as the component ratio based on film thickness. Tris(8-hydroxyquinoline)aluminum complex (Alq₃) was stacked in a film thickness of 22.4 nm as the electron transport layer. For the purposes of the present invention, the “component ratio based on film thickness” means the ratio given by the film thicknesses produced when each component is vapor deposited by itself.

Then, without breaking the vacuum and using a mask that generated a stripe pattern (width=0.3 mm, pitch=0.33 mm) that extended in a second direction orthogonal to the first direction, LiF (film thickness=1 nm)/Al (film thickness=100 nm) were deposited to form a reflective electrode 90 comprising a plurality of stripe-shaped subelectrodes.

The laminate obtained as described above was transferred into a dry nitrogen atmosphere (moisture concentration no more than 10 ppm) in a glove box, and the organic EL device was obtained by sealing using a getter-coated sealant glass and a UV-curing adhesive (neither are shown).

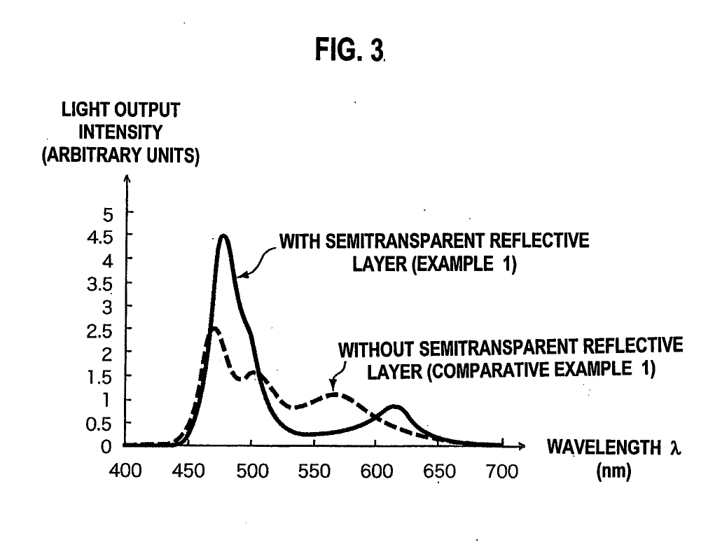

In addition, using the same procedures as described in the preceding, a device for measurement of the organic EL emission spectrum was fabricated by sequentially layering the semitransparent reflective layers 60, transparent electrodes 70, organic EL layer 80, and reflective electrode 90 directly on the transparent substrate 10. The emission spectrum was measured by inducing the emission of all of the light-emitting elements in the resulting device for measurement of the organic EL emission spectrum. The results are shown with a graph using a solid line in FIG. 3.

### Example 2

An organic EL device having the structure shown in FIG. 1 was fabricated by repeating the procedures of Example 1, but in this case without producing the red conversion layer 30R.

### Example 3

Color filter layers 20 (R, G, B), color conversion layers 30 (R, G), a planarization layer 40, and a passivation layer 50 were formed on a transparent substrate 10 by repeating the procedures of Example 1. Then, using the same conditions as in Example 1, semitransparent reflective layers 60 were formed in the positions corresponding to the blue and green color filter layers 20 (B, G). Transparent electrodes 70 (film thickness=220 nm) comprising IZO was subsequently formed using the same conditions as in Example 1.

The transparent electrode 70-equipped laminate was then installed in a resistance-heated vapor deposition apparatus and an organic EL layer 80 having an overall film thickness of 225 nm and comprising a hole injection layer, a hole transport layer, a light-emitting layer, and an electron transport layer was formed by sequential film formation without breaking the vacuum. The pressure in the vacuum chamber during film formation was dropped to 1×10⁻⁵ Pa. The hole injection layer was formed as a co-vapor-deposited film (film thickness=180 nm) of m-MTDATA and F4-TCNQ in which m-MTDATA:F4-TCNQ=100:2 as the component ratio based on film thickness. α-NPD was layered in a film thickness of 10 nm as the hole transport layer. The light-emitting layer was formed by layering a co-vapor-deposited film (film thickness=15 nm) of DPVBi, the green dopant GD-206 (from Idemitsu), and the red dopant RD-001 (from Idemitsu) in which DPVBi:GD-206:RD-001=100:3:0.15 as the component ratio based on film thickness. Alq₃ was then layered in a film thickness of 20 nm as the electron transport layer.

The organic EL device was thereafter obtained by carrying out formation of the reflective electrode 90 and sealing using the same conditions as in Example 1.

### Comparative Example 1

Color filter layers 20 (R, G, B), color conversion layers 30 (R, G), a planarization layer 40, and a passivation layer 50 were formed on a transparent substrate 10 by repeating the procedures of Example 1. Transparent electrodes 70 were then formed directly on the passivation layer 50 using the same conditions as in Example 1.

The transparent electrode 70-equipped laminate was then installed in a resistance-heated vapor deposition apparatus and an organic EL layer 80 having an overall film thickness of 140.3 nm and comprising a hole injection layer, a hole transport layer, a light-emitting layer, and an electron transport layer was formed by sequential film formation without breaking the vacuum. The pressure in the vacuum chamber during film formation was dropped to 1×10⁻⁵ Pa. The hole injection layer was formed as a co-vapor-deposited film (film thickness=95.5 nm) of m-MTDATA and F4-TCNQ in which m-MTDATA:F4-TCNQ=100:2 as the component ratio based on film thickness. α-NPD was layered in a film thickness of 10 nm as the hole transport layer. The light-emitting layer was formed by layering a co-vapor-deposited film (film thickness=14.9 nm) of DPVBi, the blue dopant BD-102 (from Idemitsu), and the red dopant RD-001 (from Idemitsu) in which DPVBi:BD-102:RD-001=100:3:0.15 as the component ratio based on film thickness. Alq₃ was then layered in a film thickness of 19.9 nm as the electron transport layer.

An organic EL device was thereafter obtained by carrying out formation of the reflective electrode 90 and sealing using the same conditions as in Example 1. The obtained organic EL device differed from the organic EL device of Example 1 in that the semitransparent reflective layers 60 were not present in the former and in that the film thickness of the layer comprising the organic EL layer 80 differed between the two.

In addition, using the same procedures as described above, a device for measurement of the organic EL emission spectrum was fabricated by sequentially layering the transparent electrodes 70, organic EL layer 80, and reflective electrode 90 directly on the transparent substrate 10. The emission spectrum was measured by inducing the emission of all of the light-emitting elements in the resulting device for measurement of the organic EL emission spectrum. The results are shown with a graph using a dotted line in FIG. 3.

### Comparative Example 2

An organic EL device was fabricated as in Example 1, with the exception that in this case the semitransparent reflective layer 60 was disposed only in the position corresponding to the blue color filter layer 20B.

Evaluation

The emission spectra are shown in FIG. 3 for the devices fabricated in Example 1 and Comparative Example 1 for measurement of the emission spectrum. The spectrum of the device of Comparative Example 1, which lacked the semitransparent reflective layers 60, presented three peaks, which were presumed to originate with the emission of the host molecule and the two dopants in the light-emitting layer; each of these peaks was also broad. On the other hand, the device of Example 1, which had semitransparent reflective layers 60 and an optimized layer thickness for the transparent electrode and organic EL layer, presented two peaks, in the blue region and the red region, and these peaks were sharp (particularly the peak in the blue region). It may be understood from these results that the resonator structure formed in the device of Example 1 is effective for amplifying the blue region and the red region in the light generated by the light-emitting elements.

Using the color filter layer 20-containing organic EL devices of the examples and comparative examples, the current efficiency (for the entire visible light region) and the luminance ratio for all of the light-emitting elements were measured during the flow of current at a current density of 0.1 A/cm². The results are shown in Table 1. The luminance ratio is the relative ratio using the luminance of the Comparative Example 1 device as the reference.

The organic EL device of Example 2 had a luminance and current efficiency that were 1.2 times that of the organic EL device of Comparative Example 1. This is thought to be due to an amplification of the blue and red light in the blue and red subpixels, which were provided with resonator structures, and also due to an increased green light intensity brought about by color conversion of the blue component at the green subpixels, which were provided with a green conversion layer 30G.

The organic EL of Example 3 had a luminance and current efficiency that were 1.14 times that of the organic EL device of Comparative Example 1. This is thought to be due to an amplification of the blue and green light in the blue and green subpixels, which were provided with resonator structures, and also due to an increased red light intensity brought about by color conversion of the blue component at the red subpixels, which were provided with a red conversion layer 30R.

The organic EL of Example 1 had a luminance and current efficiency that were 1.08 times that of the organic EL device of Example 2. This is thought to be due to amplification brought about by the presence of the resonator structure in the red subpixels and also due to an additional increase in the red light intensity brought about by color conversion of the blue component.

The organic EL device of Example 1 had a luminance and current efficiency that were 1.24 times that of the organic EL device of Comparative Example 2. This is thought to be due to amplification of the blue light brought about by the presence of the resonator structure in the red subpixels provided with a red conversion layer 30R whereby color conversion of the blue component then made a substantial contribution to increasing the intensity of the red light.

TABLE 2
Device properties

| | current efficiency | |
|---|---|---|
| | (cd/A) | luminance ratio |
| Example 1 | 2.8 | 1.30 |
| Example 2 | 2.6 | 1.20 |
| Example 3 | 2.5 | 1.14 |
| Comparative Example 1 | 2.2 | 1.00 |
| Comparative Example 2 | 2.3 | 1.05 |

### Comparative Example 3

Color filter layers 20 (R, G, B), color conversion layers 30 (R, G), a planarization layer 40, and a passivation layer 50 were formed on a transparent substrate 10 by repeating the procedures of Example 1.

Then, using the same conditions as in Example 1, a semitransparent reflective layers 60 were formed in the positions corresponding to the color filter layers 20 for all the colors.

Transparent electrodes 70 comprising IZO with a film thickness of 220 nm were subsequently formed using the same conditions as in Example 1.

The transparent electrode 70-equipped laminate was then installed in a resistance-heated vapor deposition apparatus and an organic EL layer 80 having an overall film thickness of 279 nm and comprising a hole injection layer, a hole transport layer, a light-emitting layer, and an electron transport layer was formed by sequential film formation without breaking the vacuum. The pressure in the vacuum chamber during film formation was dropped to 1×10⁻⁵ Pa. The hole injection layer was formed as a co-vapor-deposited film (film thickness=229 nm) of m-MTDATA and F4-TCNQ in which m-MTDATA:F4-TCNQ=100:2 as the component ratio based on film thickness. α-NPD was layered in a film thickness of 10 nm as the hole transport layer. The light-emitting layer was formed by layering a co-vapor-deposited film (film thickness=20 nm) of DPVBi, the blue dopant BD-102 (from Idemitsu), and the red dopant RD-001 (from Idemitsu) in which DPVBi:BD-102:RD-001=100:3:0.15 as the component ratio based on film thickness. Alq₃ was then layered in a film thickness of 20 nm as the electron transport layer.

An organic EL device was subsequently obtained by carrying out formation of the reflective electrodes 90 and sealing using the same conditions as in Example 1. The obtained organic EL device differed from the organic EL device of Example 1 in that a resonator structure was provided for all three emission colors (blue, green, and red) by changing the disposition of the semitransparent reflective layers 60 and the film thickness of the organic EL layer.

The driving voltage of this comparative organic EL device was higher than the driving voltage of the organic EL device of Example 1, and as a result the power consumption of this comparative organic EL device was also higher than that of the device of Example 1. This result is presumed to be due to fact that the film thickness of the organic EL layer 80 had to be increased in order to realize a resonator structure for all of the emission colors.

What is claimed is:

1. An organic EL light-emitting display device having an array of pixels, comprising:
a reflective electrode;
a transparent substrate; and
a light-emitting organic EL layer disposed adjacent the reflective electrode and between the transparent substrate and the reflective electrode,
wherein the display device additionally includes, for each pixel,
a first transparent electrode in a first color subpixel region,
a first semitransparent reflective element in the first color subpixel region to function with the reflective electrode as a resonator for light of the first color, the first semitransparent reflective element being disposed between the transparent substrate and the first transparent electrode,
a second transparent electrode in a second color subpixel region,
a second semitransparent reflective element in the second color subpixel region to function with the reflective electrode as a resonator for light of the second color, the second semitransparent reflective element being disposed between the transparent substrate and the second transparent electrode,
a third transparent electrode in a third color subpixel region, and
a color conversion element in the third color subpixel region, the color conversion element being disposed between the third transparent electrode and the transparent substrate.

2. The display device of claim 1, wherein the color conversion element absorbs light of at least one of the first and second colors and converts at least some of the absorbed light to light of the third color.

3. The display device of claim 1, wherein the display device further includes, for each pixel,
a first color filter element in the first color subpixel region and aligned with the first transparent electrode and the first semitransparent reflective electrode,
a second color filter element in the second color subpixel region and aligned with the second transparent electrode and the second semitransparent reflective electrode, and
a third color filter element in the third color subpixel region and aligned with the first transparent electrode and the color conversion element.

4. The display device of claim 1, wherein the first and second semitransparent reflective elements have a reflectance ranging from 10% to 50%.

5. The display device of claim 4, wherein the first and second semitransparent reflective elements have a reflectance ranging from 20% to 30%.

6. The display device of claim 1, wherein light of the first color has a wavelength λ₁, light of the second color has a wavelength λ₂, wherein the organic EL layer has a thickness L between the first transparent electrode and the reflective electrode and between the second transparent electrode and the reflective electrode, wherein Φ is a phase shift upon reflection by the reflective electrode and the semitransparent reflective elements, and wherein
2L/λ1+Φ/2π=m1(m1=integer), and
2L/λ2+Φ/2π=m2(m2=integer).

7. The display device of claim 1, wherein the first color is blue, the second color is red, and the third color is green.

8. The display device of claim 7, wherein the color conversion element comprises at least one dye selected from the group consisting of 3-(2′-benzothiazolyl)-7-diethylaminocoumarin (coumarin 6), 3-(2′-benzoimidazolyl)-7-diethylaminocoumarin (coumarin 7), 3-(2′-N-methylbenzoimidazolyl)-7-diethylaminocoumarin (coumarin 30), and 2,3,5,6-1H,4H-tetrahydro-8-trifluoromethylquinolidine(9,9a,1-gh)coumarin (coumarin 153);
basic yellow 51, solvent yellow 11, and solvent yellow 116.

9. The display device of claim 1, wherein the first color is blue, the second color is green, and the third color is red.

10. The display device of claim 9, wherein the color conversion element comprises at least one dye selected from the group consisting of rhodamine B, rhodamine 6G, rhodamine 3B, rhodamine 101, rhodamine 110, sulforhodamine, basic violet 11, and basic red 2; cyanine dyes, 1-ethyl-2-[4-(p-dimethylaminophenyl)-1,3-butadienyl]pyridinium perchlorate (pyridine 1), and oxazine dyes.

11. A display device, comprising:
a reflective electrode;
a transparent layer that is spaced apart from the reflective electrode; and
an electro-optic layer between the reflective electrode and the transparent layer,
wherein the display device additionally includes, for each pixel,
a first transparent electrode supported on the transparent layer in a first color subpixel region,
a first semitransparent reflective element supported on the first transparent electrode to function with the reflective electrode as a resonator for light of the first color, the first semitransparent reflective element being separated from the reflective electrode by material of the electro-optic layer,
a second transparent electrode in a second color subpixel region,
a second semitransparent reflective element supported on the second transparent electrode to function with the reflective electrode as a resonator for light of the second color, the second semitransparent reflective element being separated from the reflective electrode by material of the electro-optic layer, and
a third transparent electrode in a third color subpixel region.

12. The display device of claim 11, wherein the display device further includes, for each pixel, a color conversion element in the third color subpixel region, the color conversion element being aligned with the third transparent electrode.

13. The display device of claim 11, wherein the electro-optic layer comprises an organic EL layer.
